(19) United States
(12) Patent Application Publication
(10) Pub. No.: US 2021/0145161 A1
(43) Pub. Date: May 20, 2021

(54) APPLICATOR FOR APPLYING A COSMETIC COMPOSITION

(71) Applicant: VINCENI PROPERTY II UG, Mannheim (DE)

(72) Inventor: Ferdinand FÜTTERER, Baden-Baden (DE)

(21) Appl. No.: 17/254,972

(22) PCT Filed: Jun. 26, 2019
(86) PCT No.: PCT/EP2019/066968

§ 371 Date: Dec. 22, 2020

(30) Foreign Application Priority Data
Jun. 28, 2018 (DE) 10 2018 115 698.7

(51) Int. Cl. A46B 9/02; A45D 40/26; A46B 3/00; A46D 1/00; B29C 45/00

(52) U.S. Cl. CPC A46B 9/028; A45D 40/262; A46B 3/005; A46B 9/021; B29C 45/2626; A46D 1/0207; B29C 45/0053; A46B 2200/1053; A46D 1/0238

(57) ABSTRACT

An applicator for applying a cosmetic composition to the human body having a substantially cylindrical base body, and bristles with flock fibers arranged on and protruding from the base body and distributed over the periphery of the base body.

The invention relates to an applicator for applying a cosmetic composition to the human body, comprising a substantially cylindrical base body, wherein bristles protrude from the base body, wherein the bristles are arranged on the base body distributed over the periphery.

Such applicators are used mostly in combination with the application of liquefied cosmetics in the facial area. Bristle-type applicators are used e. g. for taking up and applying mascara, eyebrow make-up, concealer and foundation or for applying hair care products. For picking-up and application purposes, the applicator is dipped into a cosmetics container, wherein, after the applicator is removed, the cosmetic adheres to the bristles and is then applied to parts of the body, in particular parts of the face.

In particular, if the base body has been produced together with the bristles in an injection-molding process, because of the production procedure means, the bristles are relatively widely spaced apart from one another. As a result, the amount of cosmetics picked up by said applicator is limited.

The object of the invention is to provide an applicator which has a greater pick-up capacity for cosmetics and is comfortable to handle.

This object is achieved by the features of claim 1. The dependent claims refer to advantageous embodiments.

In order to achieve the object, the bristles are provided with flock fibers. Preferably, the flock fibers are applied merely to the bristles, whereas the base body is free of flock fibers. This produces a multiplicity of intermediate spaces between the bristles, in which cosmetics can be picked up. Furthermore, the applicator according to the invention is particularly suitable for applying cosmetics which have a low viscosity. Low-viscosity cosmetics do not adhere to synthetic material bristles to an adequate extent. However, due to the flocking arrangement, the applicator according to the invention has a high degree of porosity in the region of the bristles and is thus highly suitable for picking up and then also releasing low-viscosity cosmetics.

The base body is essentially cylindrical, wherein, however, it is basically also feasible for the base body to have a conical or conoidal shape with a diameter which decreases towards the tip of the base body. Thereby, the base body is always formed rotationally symmetrical. The applicator together with the base body and bristles is circular when viewed in cross-section and, therefore, is particularly suitable for being dipped into a cosmetics container which has an opening with an external thread. The applicator can be provided with a handle piece which simultaneously serves as a lid and is provided with an internal thread which is congruent to the external thread.

The bristles are arranged on the base body, preferably distributed uniformly over the periphery. The bristles can be arranged in a helical manner around the base body or can be aligned in the axial direction. Preferably, the bristles distributed over the peripheral region of the base body are provided with flock fibers. In the case of the embodiment of the base body in cylindrical, conical or conoidal form, the bristles provided with flock fibers are distributed over the entire periphery of the base body, i. e. over 360 degrees.

Preferably, the base body and bristles consist of synthetic material. Thereby, it is feasible to form the base body and bristles from different materials. Particularly soft bristles can be achieved through the use of rubbery-elastic materials. Such materials are e. g. elastomers, silicones, rubbers, thermoplastic elastomers or thermosetting elastomers.

Preferably, the bristles are formed from the same material as and in one piece with the base body. This permits cost-effective production of an applicator provided with bristles.

The base body and the bristles can be formed from injection-moldable synthetic material. In the case of this embodiment, the base body provided with bristles can be produced cost-effectively in an injection-molding process. It is not necessary to attach the bristles to the base body in a separate working step. However, in order to be able to produce a base body provided with bristles in an injection-molding process, it is necessary to arrange the bristles in a regular manner and to provide a spaced interval between the bristles. The disadvantage of the resulting relatively large intermediate spaces is compensated for by the inventive provision of flock fibers on the bristles. On the one hand, the flock fibers provide a soft and pleasant feel which is advantageous, if a cosmetic is to be applied to sensitive parts of the body.

Furthermore, there is a multiplicity of small intermediate spaces in the region of the bristles which permits a larger amount of cosmetic to be picked up, while, at the same time, making it possible to apply the cosmetic to the part of the body with precision. When different materials are used for the base body and the bristles, the applicator can be produced during the course of a two-component injection-molding procedure.

The bristles can protrude radially from the base body. When viewed in the axial direction, the bristles can be arranged in rows or can surround the base body in a helical manner. Due to the radially protruding bristles, a voluminous applicator is produced which can pick up a large amount of cosmetic.

The flock fibers are connected to the bristles preferably in an integrally bonded manner. According to one advantageous method, for flocking purposes the bristles of the applicator are provided with an adhesive and flock fibers are subsequently applied, wherein for flocking purposes an electrostatic field is produced which acts upon the applicator. As a result, the flock fibers are introduced into the adhesive bed and are oriented substantially perpendicularly with respect to the surface of the bristles. The adhesive is preferably applied to the applicator in such a manner that it wets merely the bristles, whereas the base body is free of adhesive. This can prevent flock fibers and adhesive from accumulating on the base body and thereby reducing the free length of the bristles.

Flock fibers which have a titer of 3.3 dtex or less and have a length of 1.2 mm or less can be used. Preferably, flock fibers having a fiber titer between 0.9 dtex and 1.7 dtex are selected. The length of the flock fibers is preferably between 0.3 mm and 0.7 mm.

After application, the flock fibers are fixed to the bristles of the applicator and protrude perpendicularly from the bristles. As a result, the bristles and thus also the applicator have a considerably softer feel and the applicator is able to pick up a larger amount of cosmetic between the bristles.

The amount of cosmetic picked up and then released by the applicator is particularly large, if the base body is free of flock fibers.

The applicator according to the invention is particularly suitable for applying eyebrow cosmetic and for applying eyelash cosmetic. Both eyebrow cosmetic and eyelash cosmetic are applied predominantly by means of brush-like applicators. The applicator according to the invention, in which the bristles are provided with flock fibers, is particularly advantageous in this context. The flock fibers provide the applicator with a soft feel which allows cosmetic to be applied gently. Furthermore, a large amount of cosmetic can be picked up in the intermediate spaces between the flocked bristle tips and can in turn be applied in a precise manner to the desired areas.

Some embodiments of the applicator in accordance with the invention are explained in more detail in the following with reference to the figures. These show, in each case schematically:

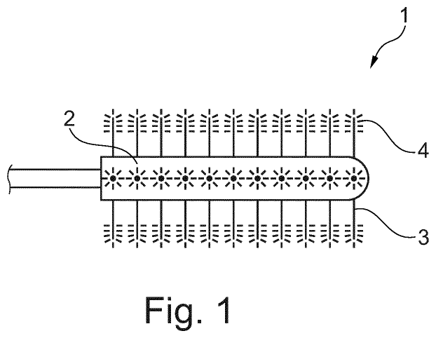

FIG. 1 an applicator with bristles arranged in a linear manner;

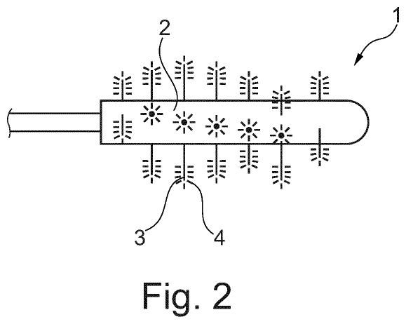

FIG. 2 an applicator with bristles arranged in a helical manner;

FIG. 1 shows an applicator 1 for applying a cosmetic composition to the human body. According to one advantageous use, the applicator 1 is used for applying eyebrow cosmetic and eyelash cosmetic.

The applicator 1 comprises a cylindrical base body 2, wherein bristles 3 protrude from the base body 2. The bristles 3 are arranged distributed around the periphery of the base body 2. The bristles 3 are formed from the same material and in one piece with the base body 2. The base body 2 and the bristles 3 are formed from injection-moldable synthetic material. The bristles 3 protrude radially from the base body 2. According to an alternative embodiment, the base body 2 is conical and has a diameter which decreases towards the tip.

The bristles 3 which are arranged distributed around the periphery of the base body 2 are provided with flock fibers 4, wherein the flock fibers 4 are connected to the bristles 3 in an integrally bonded manner.

In order to apply the flock fibers 4 to the bristles 3, an adhesive is applied to the bristles 3 and the flock fibers 4 are applied to the bristles 3 under the effect of an electrostatic field. Due to the effect of the electrostatic field, the flock fibers 4 are oriented perpendicularly to the surface of the bristles 3. In each case, a free end of the flock fibers 4 is introduced into the adhesive bed located on the bristles 3. After the adhesive has set, the flock fibers 4 are fixed to the bristles 3.

In the case of the present embodiment, the flock fibers 4 have a titer of 0.9 dtex. The fiber length is 0.3 mm.

The adhesive is applied to the applicator 1 in such a manner that the base body 2 is free of adhesive and of flock fibers 4. As a result, after completion of the flocking procedure, flock fibers 4 are located only on the bristles 3.

The base body 2 is designed to be connected to the stick of a cosmetics wand. The cosmetics wand can be connected to a lid of a cosmetics package formed as a handle. A cosmetics package includes the lid with the cosmetics wand and a cosmetics container.

In the case of the embodiment shown in FIG. 1, the bristles 3 are arranged uniformly and in rows when viewed in the axial direction.

In the case of the embodiment shown in FIG. 2, the bristles 3 are arranged distributed in a helical manner around the periphery of the base body 2. The length of the bristles 3 can vary.

1. An applicator for applying a cosmetic composition to the human body, comprising a substantially cylindrical base body, wherein bristles protrude from the base body, wherein the bristles are arranged on the base body distributed over the periphery, wherein the bristles are provided with flock fibers, wherein the flock fibers are connected to the bristles arranged distributed over the periphery of the base body in an integrally bonded manner by means of an adhesive, wherein the base body is free of adhesive and of flock fibers.

2. The applicator according to claim 1, wherein the bristles are formed from the same material and in one piece with the base body.

3. The applicator according to claim 1, wherein the base body and the bristles are formed from injection-moldable synthetic material.

4. The applicator according to claim 1, wherein the bristles protrude radially from the base body.

5. The applicator according to claim 1, wherein the flock fibers have a titer of 3.3 dtex or less.

6. The applicator according to claim 1, wherein the flock fibers have a length of 1.2 mm or less.

7. Use of the applicator according to claim 1 for applying eyebrow cosmetic.

8. Use of the applicator according to claim 1 for applying eyelash cosmetic.
